(19) United States
(12) Patent Application Publication
(10) Pub. No.: US 2008/0285403 A1
(43) Pub. Date: Nov. 20, 2008

(54) RECORDING AND REPRODUCING APPARATUS AND RECORDING AND REPRODUCING METHOD

(76) Inventor: Osamu Kawamae, Kawasaki (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 12/056,317

(22) Filed: Mar. 27, 2008

(30) Foreign Application Priority Data
Mar. 28, 2007 (JP) 2007-083273
Dec. 27, 2007 (JP) 2007-335596

(51) Int. Cl. G11B 20/10

(52) U.S. Cl. 369/47.11

(57) ABSTRACT

A recording and reproducing method of a WORM type recording disc. When a recording stop occurs, a recording stop position is stored, an access is performed again so as to continue thereto, and the recording is restarted. At this time, a recording restarting position is changed according to a factor of the recording stop, thereby enabling the proper recording to be performed. When accessing again, a parameter is changed according to the recording stop factor, thereby avoiding the recording stop from occurring again.

### INCORPORATION BY REFERENCE

The present application claims priorities from Japanese applications JP2007-083273 filed on Mar. 28, 2007 and JP2007-335596 filed on Dec. 27, 2007, the contents of which are hereby incorporated by reference into this application.

### BACKGROUND OF THE INVENTION

The invention relates to an apparatus for recording and reproducing data onto a disc-shaped recording medium and a control method of such an apparatus.

There are a DVD-ROM as a read-only media and recording type DVDs (DVD-R, DVD-RAM, DVD-RW, etc.) which can record data as DVDs (Digital Versatile Discs) and they are widely spread. The DVD-R (Recordable) among them is called a write once media or a WORM type, has such a feature that data can be recorded only once, and is used to record a video image and an audio sound or store data. An attention is paid to a Blu-ray Disc (hereinbelow, abbreviated to BD) as a recording media of a large capacity and the BD is being spread as a recording media for recording an image of high quality. There is also a disc of a kind called BD-R as a write once media.

In the case of recording data to those write once recording media, if the recording is stopped during the recording due to some reasons, the disc becomes a recording error disc and becomes a disc which cannot be used again. As shown in JP-A-5-282696 (Japanese Patent Application No. 4-76913), an information recording method whereby even when the recording has failed, the recording can be continuously performed is shown.

### SUMMARY OF THE INVENTION

In JP-A-5-282696, the method whereby when a tracking gets off during the recording and the recording is stopped, the recording is continuously performed is disclosed. As factors of the off-track, for example, there are considered an external factor in which a shock is applied from the outside or the like, a factor regarding the disc in which the tracking is largely shifted by a defect of the disc or the like and the tracking gets off, and the like.

In the case such as a shock applied from the outside, when the recording is continuously performed again from the same position, a similar disturbance is hardly applied and a state where there are no factors of the off-tracking is obtained. However, in the case of the factor based on the defect of the disc, even when the recording is continued again, such a phenomenon that the tracking is shifted occurs similarly at the same position on the disc. Therefore, a possibility that the off-tracking occurs similarly is high.

As mentioned above, even in the case of the recording stop due to the off-tracking, there are a case where the recording can be continuously performed again from the same position and a case where even if the recording is resumed as it is, the recording is not correctly executed in dependence on factors. Therefore, even if the recording is stopped, when the recording is continuously performed again, it is necessary to change processes depending on the factor of the recording stop.

To solve such problems, according to the invention, there is provided a recording and reproducing apparatus for recording data to a WORM type recording medium, comprising: a motor for rotating the recording medium; a pickup for irradiating a laser to the recording medium; a waveform equalizing circuit for waveform-equalizing a signal reproduced from the recording medium; a servo control circuit for forming a servo signal from the reproduced signal; a reproduction signal processing circuit for processing reproduction data from the reproduced signal; a recording signal processing circuit for executing a recording process to data to be recorded; a memory for storing the recording data or the reproduction data; and a system control circuit for controlling the recording and reproducing operations, wherein the apparatus has a recording stop detecting circuit for detecting that an event in which the recording should be stopped has occurred, a factor discriminating circuit for discriminating a factor of the event in which the recording should be stopped, and a storing circuit for storing information showing a position where the recording has been stopped, a length from the recording stop position to a recording restart is switched in accordance with a kind of factor, and control is made so as to restart the recording from a backward position of the stop position when the recording stop has occurred.

According to the invention, in the case where the recording is stopped during the recording, the proper recording process can be executed at the time of continuously restarting the recording again.

Other objects, features and advantages of the invention will become apparent from the following description of the embodiments of the invention taken in conjunction with the accompanying drawings.

### BRIEF DESCRIPTION OF THE DRAWINGS

FIG. 1 is a diagram showing an example of a system construction corresponding to a recording stop of the invention;

FIGS. 2A and 2B show an example of ordinary recording operation and recording stopping operation;

FIG. 3 is a diagram showing an example of a recording restarting operation at the time when the recording stop has occurred;

FIG. 4 is a diagram showing another example of the recording restarting operation at the time when the recording stop has occurred;

FIG. 5 is a diagram showing another example of the recording restarting operation at the time when the recording stop has occurred;

FIG. 6 is a diagram showing an example of a flow of a recording restarting process at the time when the recording stop has occurred;

FIG. 7 shows a construction of recording data in the case of a DVD as an example;

FIG. 8 is a diagram showing a construction of an error correction code of the recording data in the case of the DVD as an example;

FIG. 9 is a diagram showing an interleave of the recording data in the case of the DVD as an example;

FIG. 10 is a diagram showing a frame construction of the recording data in the case of the DVD as an example;

FIG. 11 is a diagram showing an example of threshold values of a tracking error signal which is inputted to off-tracking detecting circuit 114;

FIGS. 12A and 12B are diagrams showing an example of a re-recording operation at the time when the recording stop has occurred;

FIG. 13 is a diagram showing an example of a re-recording process in the case of a rewritable disc;

FIG. 14 is a diagram showing another example of the re-recording process in the case of the rewritable disc; and

FIGS. 15A to 15D are diagrams showing a difference between processes in each case regarding whether or not a defect management area has been assured in a rewriting type disc and a WORM type disc.

### DETAILED DESCRIPTION OF THE EMBODIMENTS

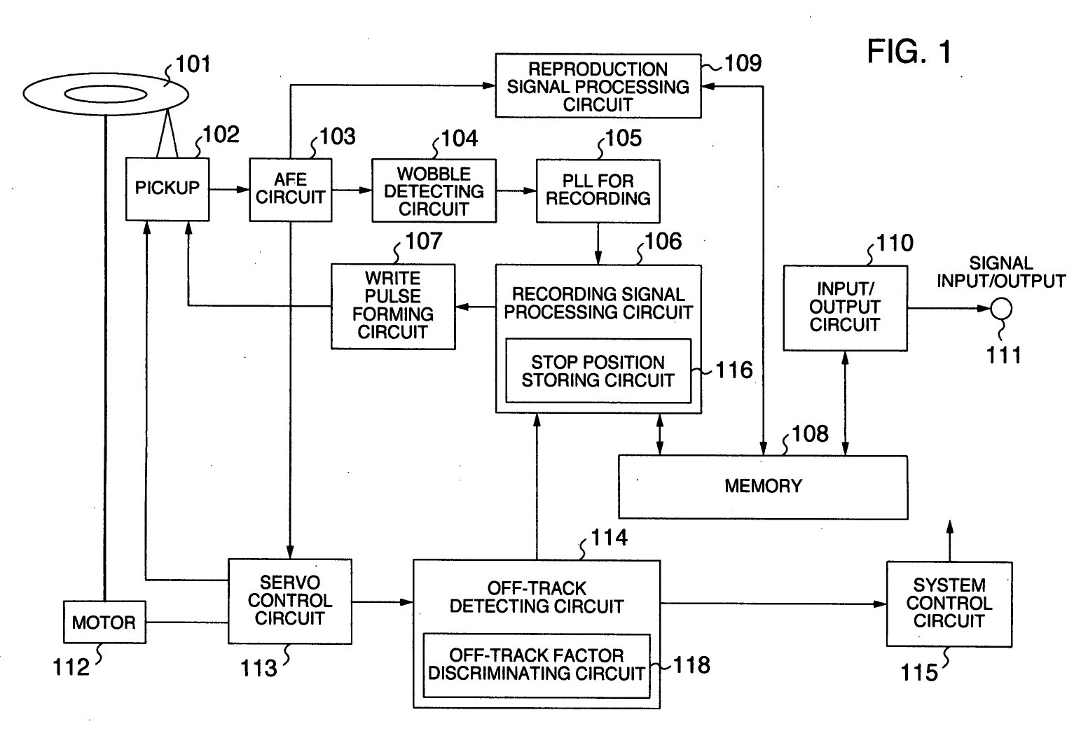

FIG. 1 is a diagram showing a system construction for realizing the invention.

Reference numeral 101 denotes a recording disc; 102 a pickup; 103 an AFE (Analog Front End) circuit; 104 a wobble detecting circuit; 105 a PLL (Phase Locked Loop) for recording; 106 a recording signal processing circuit; 107 a write pulse forming circuit; 108 a memory; 109 a reproduction signal processing circuit; 110 an input/output circuit; 111 a signal input/output; 112 a motor; 113 a servo control circuit; 114 off-tracking (hereinbelow, abbreviated to off-track) detecting circuit; 115 a system control circuit; 116 a stop position storing circuit; and 118 a off-track factor discriminating circuit.

First, the fundamental operation of the system will be described. A laser beam emitted from the pickup 102 is condensed onto a recording film of the recording disc 101, thereby reading out data on the disc or writing recording data onto the disc. A signal read out of the disc by the pickup 102 is amplified and waveform-equalized and an arithmetic operating process to form a servo signal is executed by the AFE circuit 103. Control signals for focusing control, tracking control, and the like are formed by the servo control circuit 113 by using the servo signal and the operation of the pickup is controlled. The disc 101 is likewise rotated and controlled by the motor 112 by the control signals from the servo control circuit 113.

A reproduction signal processed by the AFE circuit 103 is reproduction-processed by the reproduction signal processing circuit 109, is subjected to a demodulating process, a sync signal detection, a reproduction clock production, an error correction, and the like, and is stored into the memory 108. As a reproduction output, the data stored in the memory 108 is outputted through the input/output circuit 110. As for a wobble signal processed by the AFE circuit, address information is extracted by the wobble detecting circuit 104 from the wobble signal recorded on the disc.

Subsequently, the recording operation by the system will be described. The recording data inputted from the signal input/output 111 is stored into the memory 108 through the input/output interface circuit 110 such as an ATAPI. A correction code and the address information are added to the data stored in the memory and the resultant data is prepared as recording data by the recording signal processing circuit 106.

In the PLL circuit 105, a signal of the same frequency as that of the wobble signal is formed and a recording clock to record the data is formed based on the formed signal. The recording data prepared by the recording signal processing circuit 106 is outputted synchronously with the recording clock formed in the PLL circuit 105 for recording and converted as a laser light emission waveform by the write pulse forming circuit 107, thereby allowing a laser of the pickup 102 to be emitted.

Control of the whole system such as switching between the recording and reproducing operations, positioning of the pickup which is executed by searching for an address, and the like is made by the system control circuit 115.

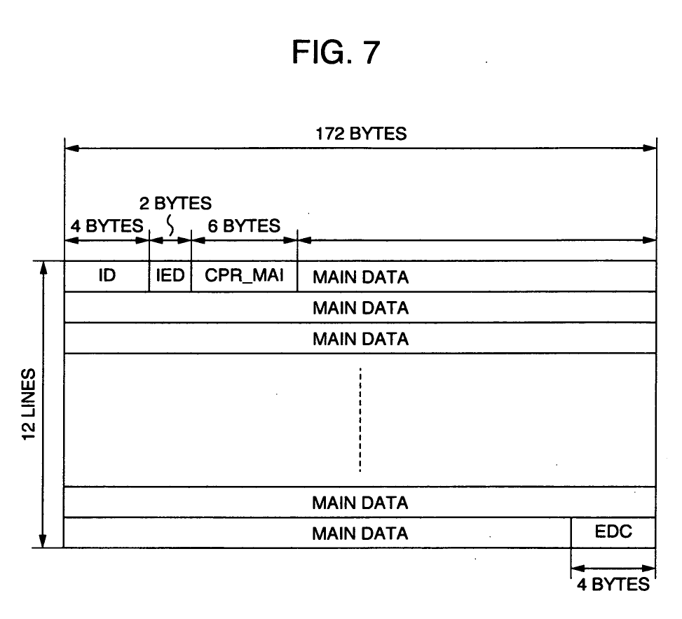

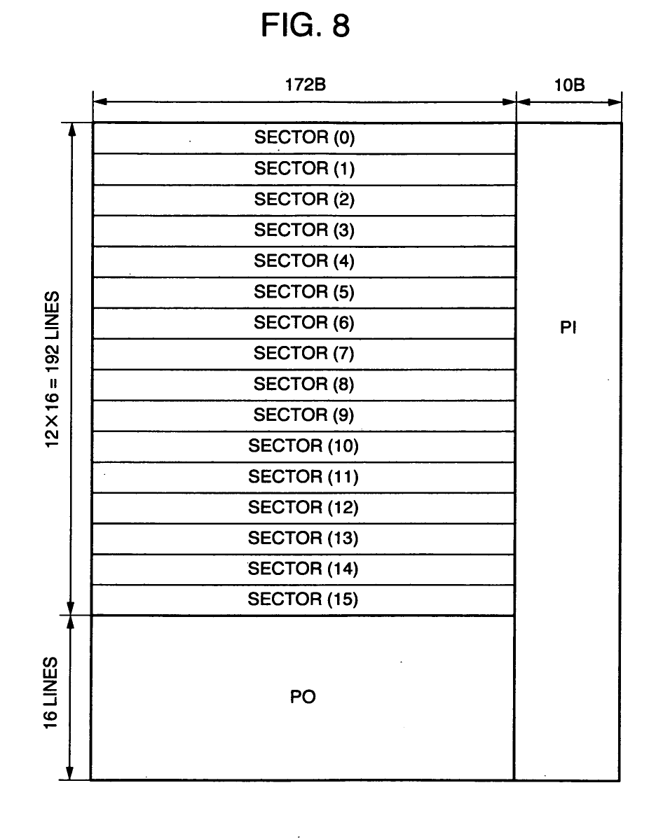

Subsequently, a data format of the DVD is shown as an example of a data construction. As for the DVD, the recording signal process is executed to data of about 32 kbytes which constitutes a unit amount of recording data. In FIG. 7, an ID of 4 bytes indicating the address, an error check code thereof, an EDC code for an error check of 4 bytes, and the like are added to the data of 2048 bytes. In this manner, one sector of 172 bytes×12 lines is constructed. In FIG. 8, with respect to the sector shown in FIG. 7, a data block is constructed by collecting 16 sectors. Error correction codes of two directions such as PI (10 bytes×208 lines) and PO (172 bytes×16 lines) are added to the data block. Since the recording data is arranged in order in the lateral direction, a burst error can be corrected by the PO code.

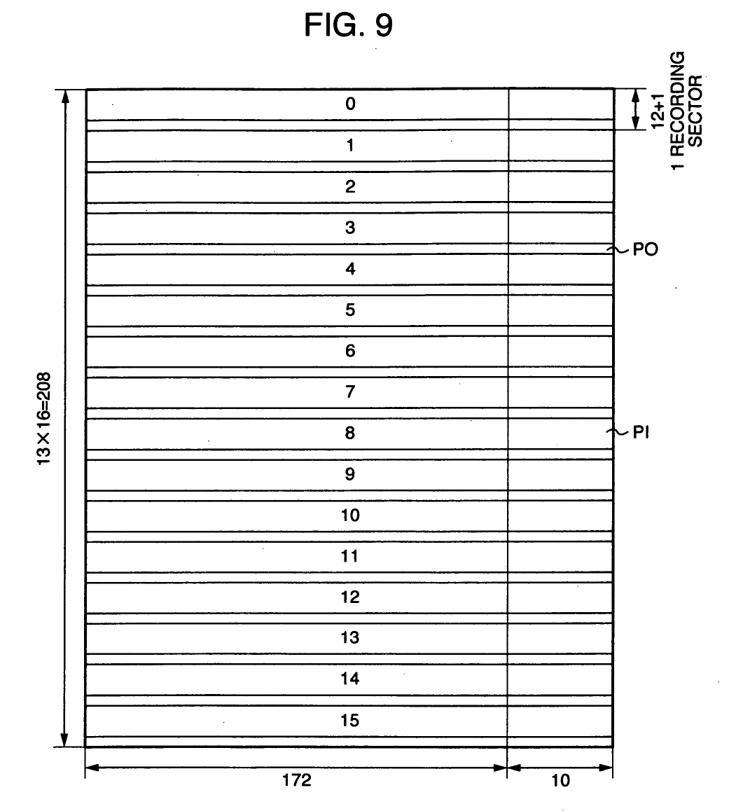

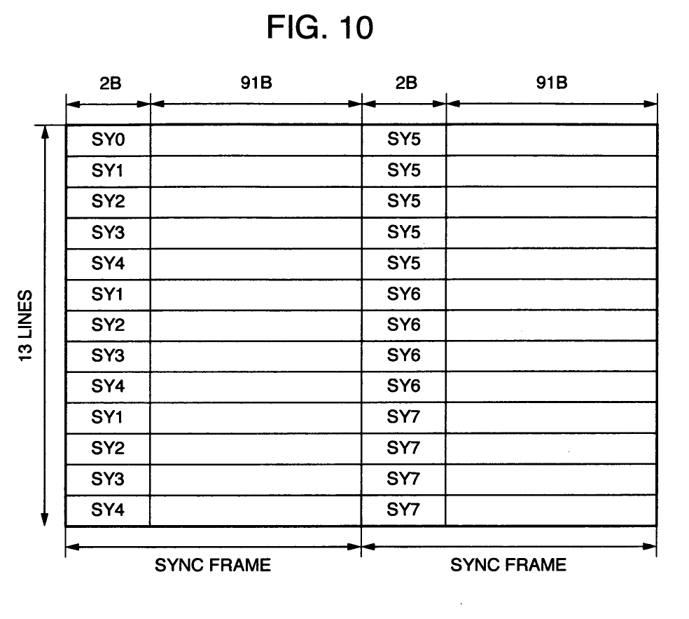

Subsequently, the PO of one line is inserted every 12 lines as shown in FIG. 9. The recording sectors are divided on a 13-line unit basis as shown in FIG. 10. A sync signal is further inserted every 91 bytes. In this instance, one sync signal is added to the data of 91 bytes. A length of one sync signal and the data of 91 bytes is called a frame. The sync signal is equivalent to a length of data of 2 bytes. As recording data, the sync signal and the data are 8-16 modulated and recorded as an actual recording signal. The sync signal can specify a position among 13 lines by the order of SY0 to SY7. The position in the recording block can be known by the ID added to the data.

In this manner, in the DVD, the position in the recording block can be identified by the ID and the sync signal. Although the method of identifying the position in the recording block as mentioned above has been shown by using a recording format of the DVD, the recording format is not limited to that of the DVD. The recording format is not particularly limited so long as it is a format in which the data is constructed by a predetermined unit. So long as it is a format in which the recording is executed while keeping a predetermined positional relation with the address information recorded on the disc, the position on the disc can be also similarly identified.

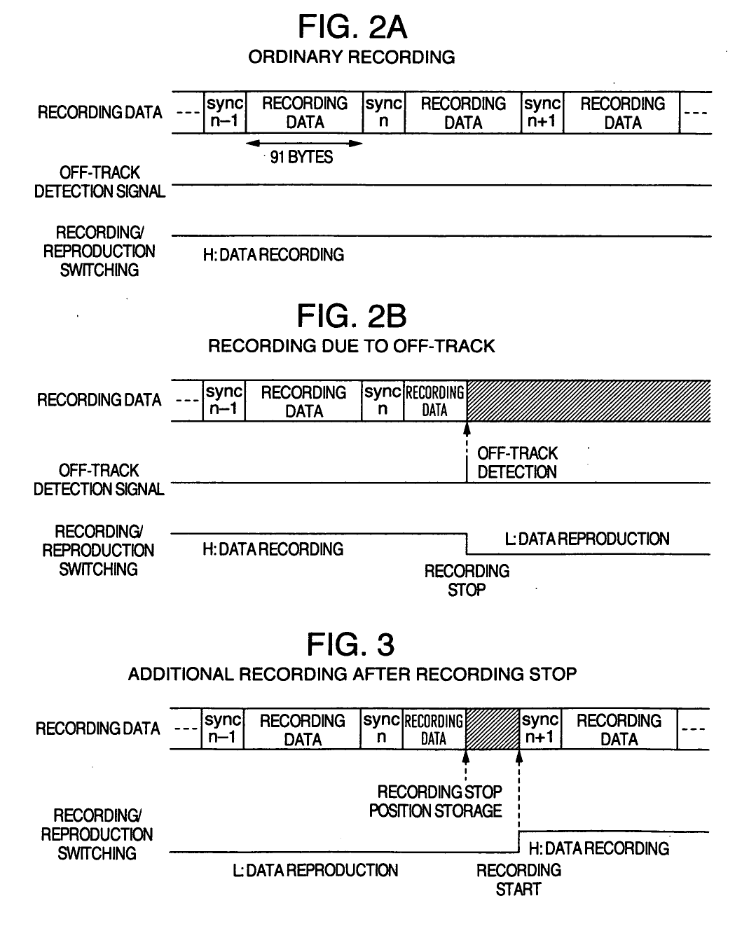

FIGS. 2A and 2B show a relation between the recording data in the recording operation and the control signals. FIG. 2A shows the ordinary recording operation. FIG. 2B shows the operation in the case where an off-track has occurred. In FIG. 2A, as recording data, the sync signal (sync) and the recording data of a predetermined length (91 bytes in the DVD) are continuously outputted in the recording mode. When no Tr-deviation detection signal is generated, a recording/reproduction switching signal is set to “H” indicative of the recording mode.

FIG. 2B shows the operation in the case where the off-track has occurred during the recording and the recording has been stopped. As for the off-track detection signal, the detection signal is outputted at the timing when the off-track has occurred. By receiving the signal, the recording/reproduction switching signal is switched from the recording mode to a reproducing mode and the recording operation is stopped. This is because when the off-track has occurred, since a condensed light spot is moved to another track, if the recording is not interrupted, the data which has already been recorded is broken by overwriting or the data is improperly recorded onto an unrecorded track.

In FIG. 2B, the off-track occurs during the recording of the recording data subsequent to the nth sync and the subsequent recording data is not recorded onto the disc. A hatched portion in the diagram shows that no data is recorded. Although the off-track has been shown as an example as a factor of the recording stop, the factor of the recording stop is not limited to it. For example, it is also possible to detect that a focusing has been lost.

When the recording is stopped and the apparatus enters an unrecording mode or state, a continuous reading error (burst error) occurs upon reproduction of the data and there is a possibility that the data cannot be corrected. Therefore, such a technique as shown in FIG. 3 is considered. It is a technique in which when the recording stop has occurred in FIG. 2B, after the recording is once stopped, the recording is resumed and restarted again. In FIG. 3, the recording is stopped on the halfway of the recording data subsequent to the nth sync, the recording stop position is stored, and subsequently, the recording is continuously restarted from this position again.

If information showing at which position the recording has been stopped can be stored up to a bit unit of the recording data, in the case of restarting the recording, the data can be continuously recorded substantially without a gap and an unrecorded area can be reduced. The number of the recording data can be stored by, for example, storing the address on the memory in a state where the data has been stored.

However, ordinarily, an error correction code has been added to the recording data and even if a burst error of a certain degree exists, the data can be reproduced by executing an error correction. The operation for restarting the recording from the sync next to the recording stop position is shown in FIG. 3. The position n where the recording has been stopped due to the off-track detection is stored and the pickup is again located to the same position on the disc. When the pickup reaches the position of n+1, the mode is switched from the reproducing mode to the recording mode by the switching of the recording/reproduction switching signal. Thus, the recording is restarted from the next sync and the data can be continuously recorded.

The above operation will be described by using the system of FIG. 1. The signal to detect the off-track, for example, a tracking error signal is received from the servo control circuit 113 by the off-track detecting circuit 114. When the signal exceeds a predetermined threshold value, the Tr-deviation detecting circuit 114 determines that the off-track has occurred. When the off-track is detected, the stop position storing circuit 116 is notified of it, thereby storing the position where the recording has been stopped. At this time, the position which is stored may be an arbitrary position so long as the stop position of the recording data can be specified. The stop position is not particularly limited so long as it is position information such as the number of bytes from the head of the block of the recording data, the address on the memory, the position based on the sync signal, or the like which can specify the stop position by a relatively short distance. Such a short distance lies within a range of a distance at which the data can be corrected as a burst error by the error correction. In the example of FIG. 3, an example in which the recording stop position of the data has been stored on a sync unit basis and an example in which the recording is restarted synchronously with the (n+1)th sync.

The system control circuit 115 is notified of the stored position information. In the system control circuit 115, after the recording was once stopped, the pickup is again located to the same position on the disc and the recording is restarted so that the data becomes continuous as much as possible. That is, in the recording signal processing circuit 105, the operation to record the same data block as that of the recording data at the time when the recording has been stopped is again executed, thereby restarting the recording on the basis of the position information of the recording stop. The recording restart can be easily realized by changing the operating mode from the reproducing mode to the recording mode by the recording/reproduction switching signal.

As for the recording data stored in the memory 108, ordinarily, the recorded data is abandoned and new recording data is stored. However, when the recording stop has occurred, the data of the recording block is not abandoned but is stored. The data is stored into the memory until the data is recorded after the recording is subsequently restarted. At this time, the data obtained after the recording is managed on the memory by using a recording end flag. When the recording stop has occurred, the data can be managed by setting the recording end flag to a non-end flag.

The position to actually restart the recording is not limited to the position of the (n+1)th sync signal but the recording may be start from a position which is slightly before the sync signal. In a portion where the data is not recorded, there is a possibility that a PLL for data reproduction is not correctly operating. It is necessary to provide a preamble period for needing a pull-in period until the PLL forms the clock synchronously with the reproduction data. It is also necessary that the PLL synchronously forms the clock in order to correctly detect the sync signal. It is useful to restart the recording of the data from a position slightly before the sync signal.

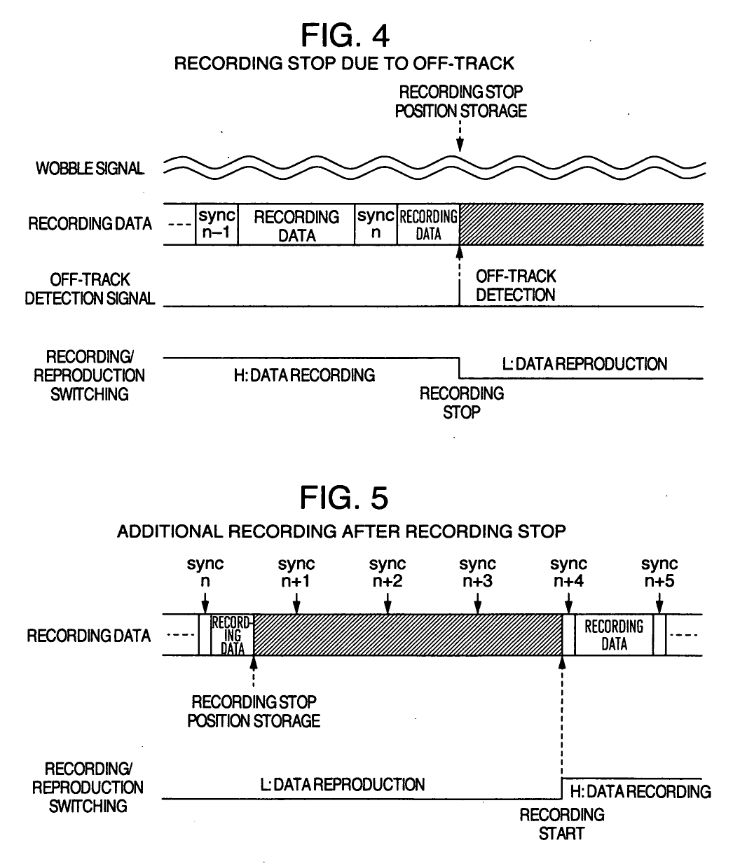

FIG. 4 shows an example in which the recording stop position and the recording restarting position are controlled by the wobble signal while they are controlled by the sync signal in FIGS. 2A, 2B, and 3. The wobble signal has previously been recorded on the disc on a predetermined length unit basis and can be used as position information. In FIG. 4, although the recording stop position information is also stored in a manner similar to FIGS. 2A and 2B, it is controlled by the wobble signal. Although the sync signal is information which is recorded as a part of the data onto the disc, since the wobble signal has been recorded on the disc even in a state where no data is recorded, reading reliability is high. This is because a relation of the position where the data is recorded is also held constant.

FIG. 5 shows the operation in the case where the position to restart the recording is adapted according to the recording stop factor. As mentioned above, when the tracking is deviated, since there is a possibility that the recorded data is broken or the data is improperly recorded onto another track, the recording is stopped. As factors of the tracking deviation, there are the following various factors: a factor due to a disturbance like a case where a shock has been applied from the outside; a factor due to the disc itself like a case where the disc itself has been manufactured in a track fluctuating state due to a defect on manufacturing; a factor due to an abnormal operation of the recording signal processing circuit or the servo control processing circuit; and the like.

In the case of the factor due to the disturbance, it is accidental and there is hardly a case where the same phenomenon occurs again at the same position. However, in the case of the factor due to the disc itself, the same phenomenon repetitively occurs at the same position. For example, in the case where a defect such as a bubble is caused or a foreign matter is mixed upon disc manufacturing, such a phenomenon occurs at the same position on the disc and its influence continues for an area of a certain extent. On the track, there is also a case where such an influence continues for an area corresponding to a tens to hundred bytes or a few frames. However, since a permissible size has generally been specified as a size of defect or foreign matter, it is not extremely larger than the permissible size. In the case of the defect or foreign matter, in many cases, the cause can be specified from the detected servo signal. By accessing the same location again, nothing is detected in the case of the accidental disturbance. However, in the case where a scratch or the like of the disc itself is a factor, the similar servo signal is detected and it is possible to decide that such a scratch is a disc factor.

In FIG. 5, when the influence of the defect continues by a length of about 3 frames due to the specific factor, the recording in such a portion is not restarted but the recording is restarted from the area where the recording can be stably executed (from n+4 in the diagram). Upon analysis of the factor, not only the disturbance is detected from the servo signal but also the disturbance can be detected by a method whereby it is detected by using a device annexed to the outside, for example, a sensor or the like for sensing an acceleration and it is detected from a direction and a magnitude of the acceleration that the is the disturbance.

As mentioned above, by switching the factor of the accidental recording stop due to the disturbance and the factor of the recording stop having reproducibility due to the disc factor, the length from the recording stop position to the recording restart can be switched. In the case of the disturbance, the control for the recording restart can be also made without making an unrecording area at all. Further, by discriminating the factor of the recording stop in detail, such a length can be properly set to the length to the recording restart according to the factor.

In FIG. 1, reference numeral 118 denotes a off-track factor discriminating circuit. As mentioned in the operation description in FIG. 5, the factor is discriminated by the off-track factor discriminating circuit 118 and the system control circuit 115 is notified of it and the period to the recording restart according to the factor can be set from the information in the stop position storing circuit 116.

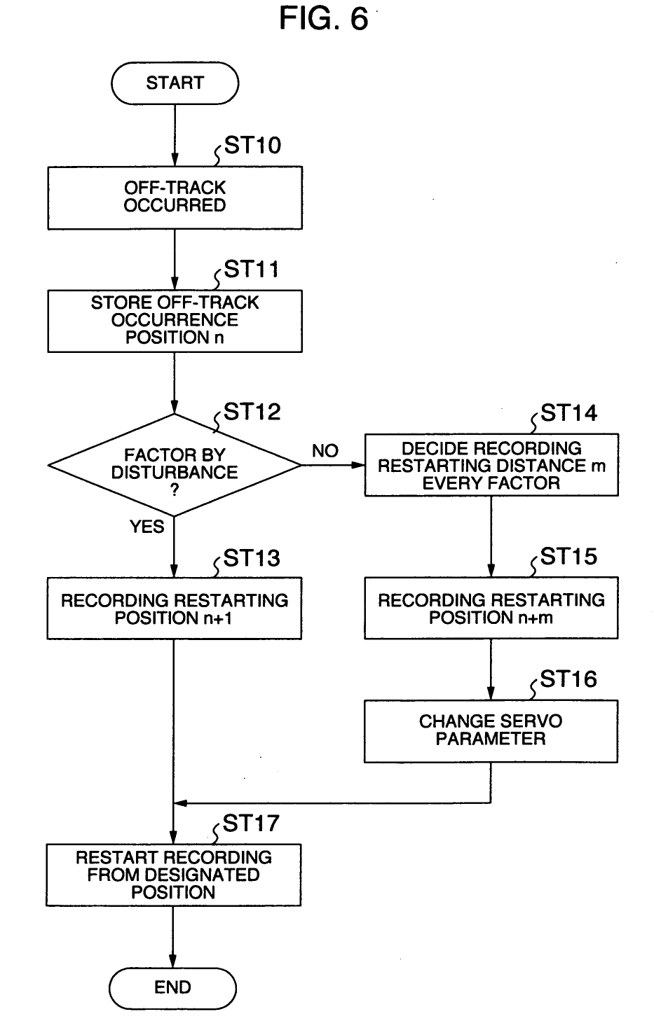

FIG. 6 shows a flow for processes which are executed until the recording is restarted after the recording stop due to the off-track occurred.

It is assumed in ST10 that the off-track has occurred during the recording. In ST11, the position n where the off-track has occurred is recorded. In next ST12, the factor of the off-track is discriminated and the processing routine is branched in accordance with whether the off-track occurs by the accidental factor due to the disturbance or it occurs again at the same position. If it is determined that the off-track occurs by the accidental disturbance from the outside of the apparatus, the recording restarting position is set so that the unrecording period is set as shorter as possible than that in the case of the off-track due to the factor of the disc itself in which it occurs again at the same position. In this instance, the recording restarting position is set so that the recording is restarted from the position of n+1 in ST13. Although n+1 indicates the number of frames based on the number of the sync shown in FIG. 3, the unit of the distance which is set is not limited to such a value but the recording can be also restarted just after the recording stop.

If the discrimination in ST12 is NO, a distance m where the recording is not executed is decided in accordance with the discriminated factor in ST14. For example, it is constructed so that the distance until the recording restart can be changed according to the factor in the following manner: if the pickup is largely swung in the tracking direction, m=1; if the pickup is largely swung in the focusing direction, m=2; and if the pickup is largely swung in both of the above directions, m=3. However, such a distance is set to a value within a range where the correction can be easily made by the error correction. In ST15, the recording restarting position is set by adding the distance m according to each factor to the recording stop position.

By controlling so as to access by using the recording restarting position as a target, the pickup can be also located to the target position without passing through a defective position on the disc. For example, when there is a disc defect at the nth frame and the tracking gets off, if the recording restarting position is assumed to be n+m (for example, it is assumed that m=3), it is preferable that the pickup is located to the position which is 3 frames after the position where the defect exists. Consequently, since the pickup does not pass through the defect existing at the location of the nth frame, the off-track does not occur again. By this method, the pickup can be located to the position n+m and the recording can be restarted therefrom.

If the factor of the off-track is based on the fluctuation of the servo, before accessing the same position again, parameters of the servo are changed in ST16, thereby making it difficult to be influenced by the factor. Thus, it is possible to prevent the off-track from occurring at the same location again. As parameters of the servo, the following methods are considered: tracking performance against a scratch is improved by changing a tracking gain, a focusing gain, or frequency characteristics of a phase or changing characteristics of an equalizer or a filter; or a threshold value of the scratch detection is changed, thereby making it difficult to be influenced by the scratch. A recording speed can be also changed by changing characteristics of a spindle motor. Although the servo has been mentioned here as an example of the parameter which is changed in order to eliminate the stop factor at the time of the re-access, it is sufficient to change an amplification of an amplitude level of the signal, a constant of the PLL for recording, a filter constant of the wobble detection, a detection holding period of the sync signal, and the like in accordance with the factor.

After the recording restarting position was determined and the parameters were optimized as mentioned above, the same recording position is accessed and the recording is restarted from the designated position in ST17. Thus, the recording can be restarted at the proper distance from the recording stop position.

By executing such processes, the recording can be restarted by the proper parameters to the disc whose recording has been stopped due to some factors and the reliability of the data recording can be improved.

FIG. 11 shows an example of threshold values of the tracking error signal which is inputted to the off-track detecting circuit 114 shown in FIG. 1. When the track jump is performed, the tracking error signal outputs a waveform as shown in FIG. 11. If such a waveform having amplitudes in upper and lower directions as mentioned above is observed, a light spot has been moved to the adjacent track. Ordinarily, the light spot has been servo-controlled so as to be located near the center of the amplitude. Therefore, in the off-track detecting circuit 114, it is determined that the off-track has occurred when the tracking error signal exceeds a predetermined threshold value. Discrimination levels 1 and 2 are decided for the signal amplitudes adapted to stop the recording lest the data is recorded to the adjacent track, or the amplitudes are divided into upper and lower levels from the center between the amplitudes and the discrimination levels are determined for the amplitude levels. By this method, the off-track can be accurately detected. It is also possible to further provide discrimination levels 3 and 4 and in addition to the discrimination levels 1 and 2 and use them for a limitation such as reduction in recording speed or the like.

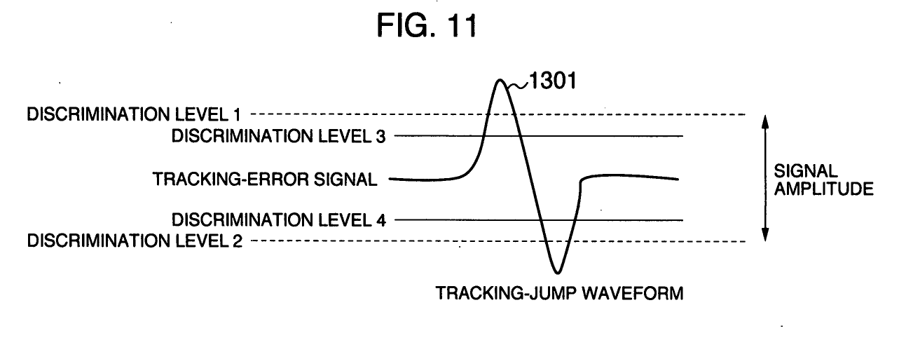

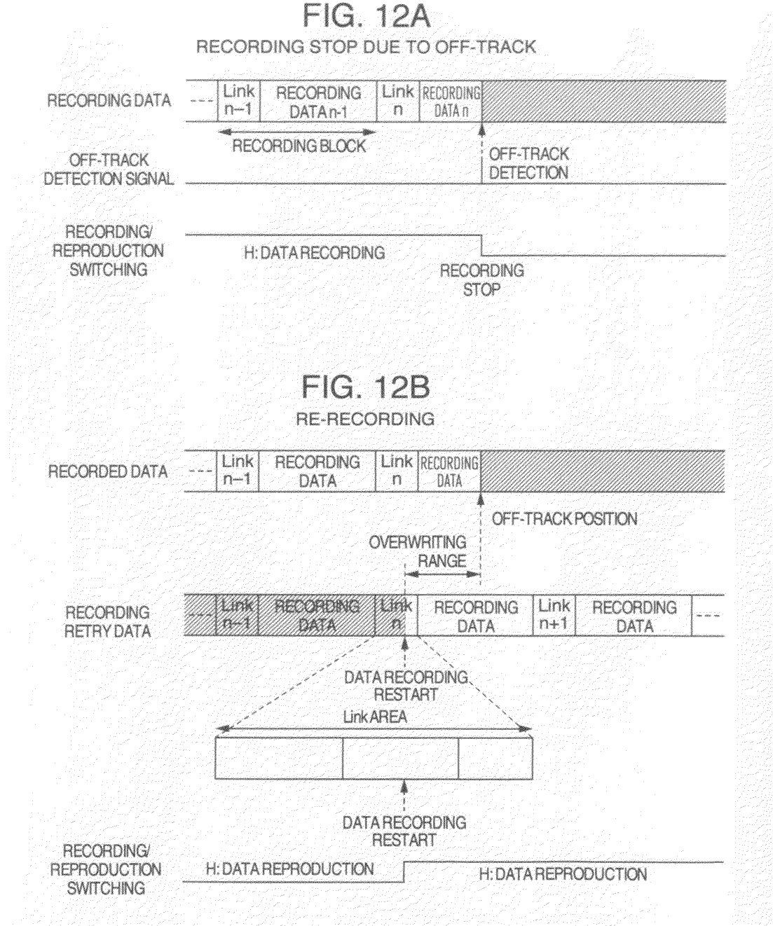

The methods whereby, when the recording stop has occurred, the recording is restarted from the continued position have been shown above. FIGS. 12A and 12B show the case of overwriting in which when the recording medium is a rewritable medium, after the recording stop occurred, the recording of the data at the same position is executed again.

FIG. 12A shows a recording stop state due to the off-track. As for the recording data, a recording block as one recording unit is constructed by combining Link area data and the recording data. The recording blocks are continuously recorded onto the disc. The off-track has been detected and the recording has been stopped here. FIG. 12B is an example showing the case where the re-recording has been executed. As shown in FIG. 12A, the recording stop has occurred on the way of the recording data n and a state where the recording data n has been recorded to the halfway is illustrated. The medium is a rewritable recording medium and the recording data n is overwritten again from a Link area n, thereby performing the re-recording. An overwrite permission area which is used for linking the recording-interrupted data together prior to recording has been provided for the Link area. The re-recording is started from this area. Although a part of the Link area n and a part of the recording data n are overwritten, there is no problem so long as a rewritable recording medium is used. By using such a method, the data whose recording has been stopped by the re-recording can be correctly recorded to the rewritable recording medium.

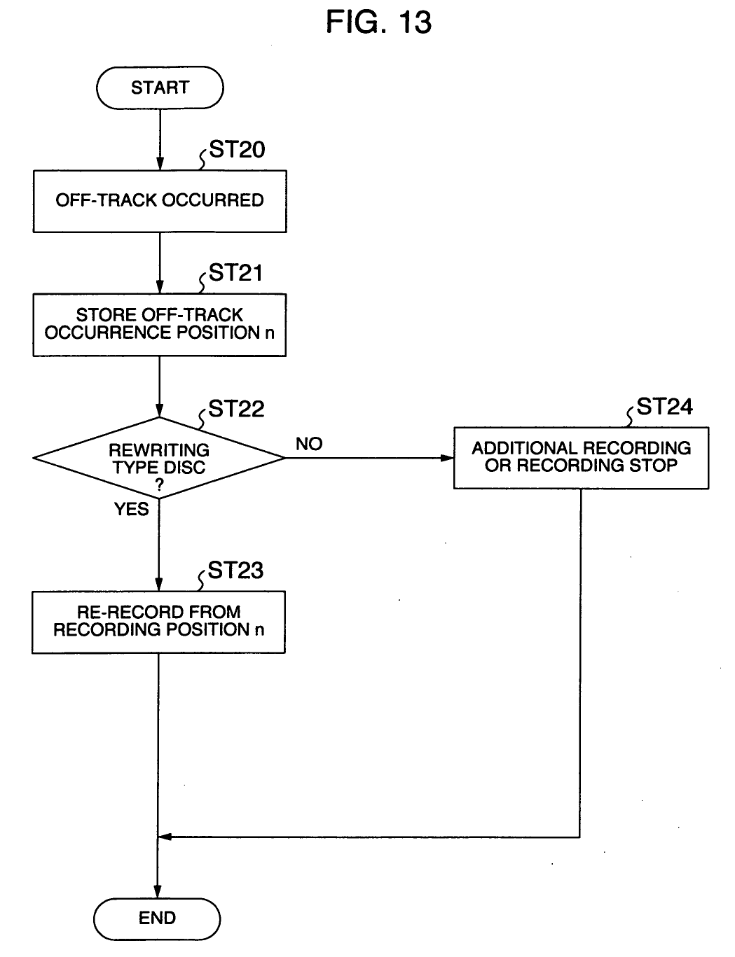

FIG. 13 shows an example of the re-recording process in the case of the rewritable disc shown in FIGS. 12A and 12B. When the tracking gets off during the recording, the off-track is detected in ST20. The recording position n where the off-track has occurred is stored in ST21. Whether or not the recording medium is a rewriting type disc (rewritable disc) is discriminated in ST22. If it is the rewriting type disc, the re-recording is executed from the recording position n in ST24. If it is not the rewriting type disc, that is, if it is the WORM type disc, the additional recording is executed or the recording is stopped. By using such a processing method, when the recording stop has occurred in the rewriting type disc, the re-recording can be executed from the data of the block whose recording has been stopped.

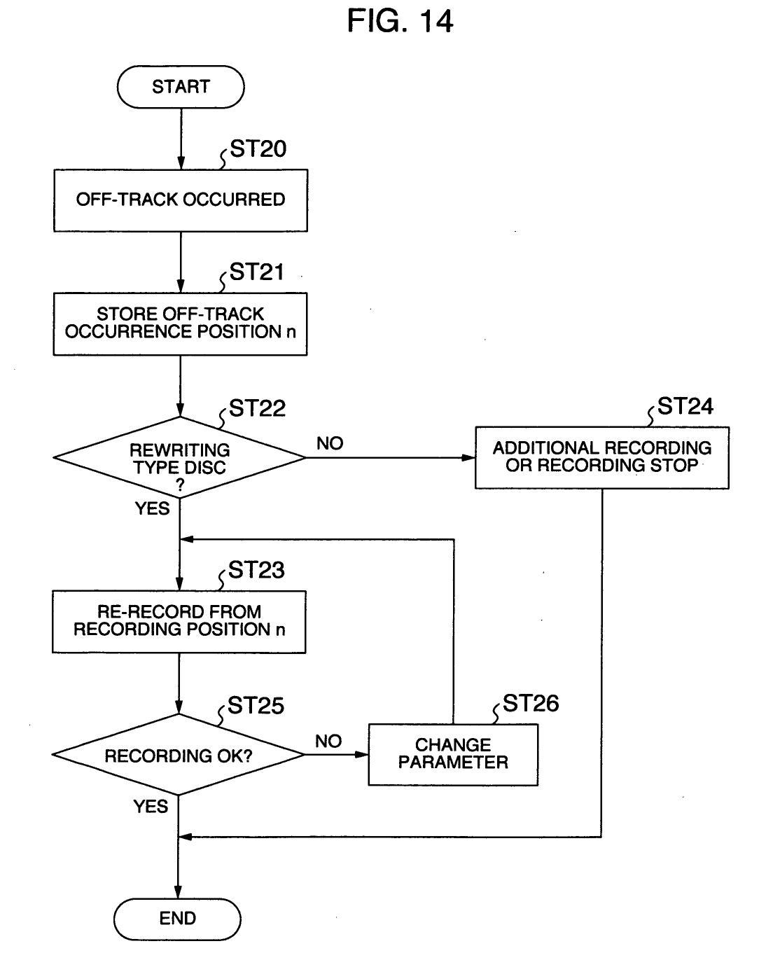

FIG. 14 shows another example of the re-recording process in the case of the rewritable disc. The same reference numerals as those in FIG. 13 indicate the same processes. ST25 is a step of confirming whether or not the recording stop does not occur because the off-track has occurred again during the recording of the recording data n, or the like. Or, it is also possible that after the recording data n was recorded, the recording data n is reproduced and whether or not the recording data n can be correctly read out is confirmed. If the data could correctly be recorded, the recording process of the next recording data is continuously executed as it is. For example, if the recording of the recording data n failed due to the influence of the scratch of the disc or the like, the parameters are changed in ST26 and the recording data n is recorded again. As a change in parameters, there is the following method: for example, the parameters of the servo are changed; by changing a scratch detection level, a scratch detecting speed is raised, thereby making it difficult to move the light spot; the servo characteristics of the scratch tracking are lightened, thereby making it difficult to be influenced by the scratch; the position of the scratch is learned and the characteristics are controlled; or the light spot is allowed to pass through the scratch by reducing the recording speed, or the like. By executing such a process, the re-recording of a plurality of times can be retried to the recording data n and the recording reliability can be improved.

In the case where the rewritable disc secures a spare area upon formatting and a defect managing process can be executed when the recording fails, after the re-recording of a plurality of times failed, the recording data n can be recorded into the spare area.

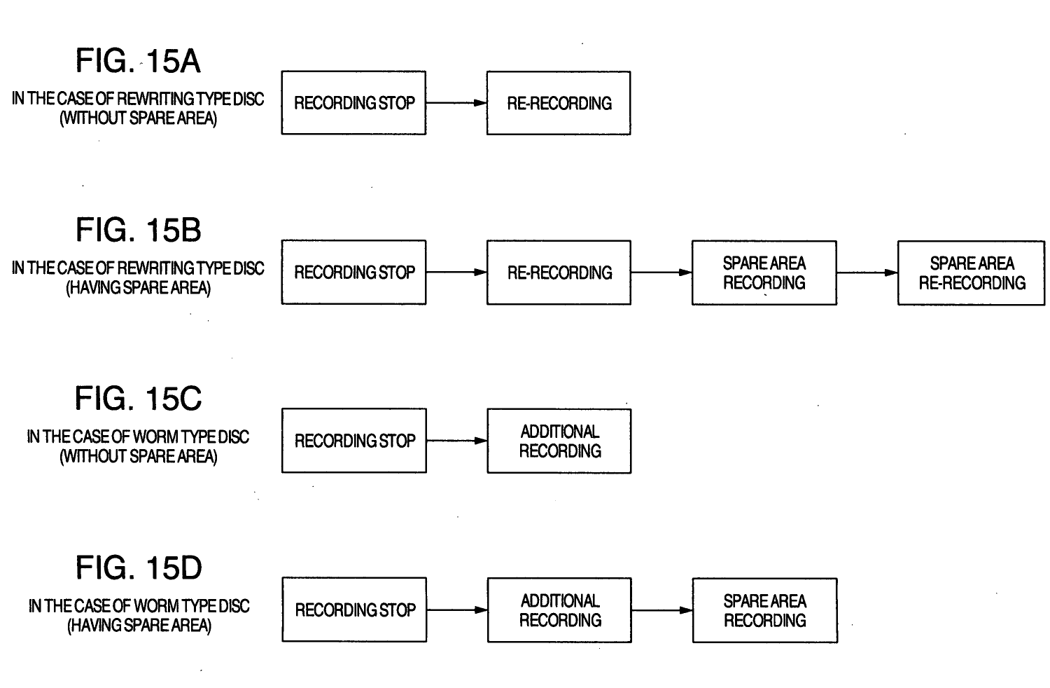

FIGS. 15A to 15D show a difference between processes in each case regarding whether or not the spare area has been secured in the rewriting type disc and the WORM type disc.

FIG. 15A: In the case of the rewriting type disc without the spare area, after the recording stop has occurred, the re-recording can be executed to the position where the recording has been stopped. The re-recording can be executed a plurality of times. In this case, by changing the parameters or the like, the recording is stabilized, thereby enabling the re-recording to be executed. If the recording cannot be executed even after the re-recording was executed, the recording becomes impossible and the recording is stopped.

FIG. 15B: In the case of the rewriting type disc in which the spare area has been secured, after the recording stop has occurred, the re-recording can be executed to the position where the recording has been stopped. Further, even after the re-recording was executed, if the recording at that position is not successful, the recording data n can be recorded in the spare area. Even if the recording stop has occurred in the spare area, the re-recording can be executed in the spare area and the data is certainly recorded.

In the cases of FIGS. 15A and 15B, the re-recording for overwriting the data is not executed but the additional recording from the position where the recording stop has occurred can be also executed. A combination process in which the additional recording and the re-recording are combined and when the additional recording fails, the re-recording is executed or the like can be also executed.

FIG. 15C: In the case of the WORM type disc without the spare area, when the recording stop has occurred, the additional recording can be executed from the position continued from the position where the recording has been stopped. If the recording cannot be executed even after the additional recording was executed, the recording fails and the recording is stopped.

FIG. 15D: In the case of the WORM type disc in which the spare area has been secured, after the recording stop has occurred, the additional recording can be executed from the position continued from the position where the recording has been stopped. Further, even after the additional recording was executed, if the recording of the recording block is not successful, the recording data n can be recorded in the spare area. Even in the spare area, even if the recording stop has occurred, the additional recording can be executed in the spare area and the data is certainly recorded.

As mentioned above, by properly combining the additional recording and the re-recording in accordance with the kind of recording medium and executing the recording process, the data can be certainly recorded and the recording reliability can be improved.

It should be further understood by those skilled in the art that although the foregoing description has been made on embodiments of the invention, the invention is not limited thereto and various changes and modifications may be made without departing from the spirit of the invention and the scope of the appended claims.

1. A recording and reproducing apparatus for recording data to a WORM type recording medium, comprising:
a motor for rotating the recording medium;
a pickup for irradiating a laser to the recording medium;
a waveform equalizing circuit for waveform-equalizing a signal reproduced from the recording medium;
a servo control circuit for forming a servo signal from the reproduced signal;
a reproduction signal processing circuit for processing reproduction data from the reproduced signal;
a recording signal processing circuit for executing a recording process to data to be recorded;
a memory for storing the recording data or the reproduction data;
a system control circuit for controlling the recording and reproducing operations;
a recording stop detecting circuit for detecting that an event in which the recording should be stopped has occurred,
a factor discriminating circuit for discriminating a factor of the event in which the recording should be stopped, and
a storing circuit for storing information showing a position where the recording has been stopped,
wherein a length from the recording stop position to a recording restart is switched in accordance with a kind of factor, and
control is made so as to restart the recording from a backward position of the stop position when the recording stop has occurred.

2. A recording and reproducing apparatus according to claim 1, wherein
said factor in which the recording should be stopped is an event in which the pickup becomes off a recording track during the recording,
in the discrimination about said factor, whether or not it is a factor caused by the recording medium is discriminated, and
control is made so as to switch the length from the recording stop position to the recording restart in dependence on a discrimination result about whether or not the factor is the factor caused by the recording medium.

3. A recording and reproducing apparatus according to claim 1, wherein
said factor in which the recording should be stopped is an event in which the pickup becomes off a recording track during the recording,
in the discrimination about said factor, whether it is a factor caused by the recording medium or an accidental factor from the outside of the apparatus is discriminated, and
in the case of the accidental factor from the outside of the apparatus, control is made so as to reduce the length from the recording stop position to the recording restart.

4. A recording and reproducing apparatus according to claim 1, wherein after the recording stop occurred, in order to restart the recording,
before the pickup is located to the same position on the recording medium,
a parameter is changed in accordance with the factor of the recording stop so as to reduce an influence of the factor.

5. A recording and reproducing method of recording data to a WORM type recording medium, comprising:
a step of rotating and controlling the recording medium;
a step of controlling a focusing and a tracking in order to locate a pickup to a predetermined position on the recording medium;
a step of reading a recording position on the recording medium;
a recording signal processing step of preparing the recording data to be recorded onto the recording medium;
a step of controlling a start and a stop of the recording to the recording medium and a restart of the recording;
a recording stop detecting step of detecting that an event in which the recording should be stopped has occurred;
a factor discriminating step of discriminating a factor of the event in which the recording should be stopped;
a step of storing information showing a position where the recording has been stopped; and
a step of switching a length from the recording stop position to a recording restart in accordance with a kind of factor,
wherein control is made so as to restart the recording from a backward position of the stop position when the recording stop has occurred.

6. A recording and reproducing method according to claim 5, wherein
said factor in which the recording should be stopped is an event in which the pickup becomes off a recording track during the recording, and
said method has a step of discriminating whether or not the factor is a factor caused by the recording medium in the discrimination about said factor, and
a step of switching the length from the recording stop position to the recording restart in dependence on a discrimination result about whether or not the factor is the factor caused by the recording medium.

7. A recording and reproducing method according to claim 5, wherein
said factor in which the recording should be stopped is an event in which the pickup becomes off a recording track during the recording, and
said method has
a step of discriminating whether said factor is a factor caused by the recording medium or an accidental factor from the outside of the apparatus in the discrimination about said factor, and
a step of controlling so as to reduce the length from the recording stop position to the recording restart in the case of the accidental factor from the outside of the apparatus.

8. A recording and reproducing method according to claim 5, comprising a step of,
after the recording stop occurred, in order to restart the recording,
before the pickup is located to the same position on the recording medium,
changing a parameter in accordance with the factor of the recording stop so as to reduce an influence of the factor.

9. A recording and reproducing apparatus for recording data to a rewriting type recording medium, comprising:
a motor for rotating the recording medium;
a pickup for irradiating a laser to the recording medium;
a waveform equalizing circuit for waveform-equalizing a signal reproduced from the recording medium;
a servo control circuit for forming a servo signal from the reproduced signal;
a reproduction signal processing circuit for processing reproduction data from the reproduced signal;
a recording signal processing circuit for executing a recording process to data to be recorded;
a memory for storing the recording data or the reproduction data;
a system control circuit for controlling the recording and reproducing operations,
a recording stop detecting circuit for detecting that an event in which the recording should be stopped has occurred; and
a storing circuit for storing information showing a position where the recording has been stopped,
wherein when the pickup accesses the recording stop position again and an event similar to the event in which the recording should be stopped is detected again,
control is made so as to change a parameter in accordance with the factor of the recording stop so that an influence of the factor is reduced.

10. A recording and reproducing method of recording data to a rewriting type recording medium, comprising:
a step of rotating and controlling the recording medium;
a step of controlling a focusing and a tracking in order to locate a pickup to a predetermined position on the recording medium;
a step of reading a recording position on the recording medium;
a recording signal processing step of preparing the recording data to be recorded onto the recording medium;
a step of controlling a start and a stop of the recording to the recording medium and a restart of the recording;
a recording stop detecting step of detecting that an event in which the recording should be stopped has occurred;
a step of storing information showing a position where the recording has been stopped; and
when the pickup accesses the recording stop position again and an event similar to the event in which the recording should be stopped is detected again,
a step of changing a parameter in accordance with the factor of the recording stop so that an influence of the factor is reduced.

11. A recording and reproducing apparatus according to claim 2, wherein
after the recording stop occurred, in order to restart the recording,
before the pickup is located to the same position on the recording medium,
a parameter is changed in accordance with the factor of the recording stop so as to reduce an influence of the factor.

12. A recording and reproducing apparatus according to claim 3, wherein
after the recording stop occurred, in order to restart the recording,
before the pickup is located to the same position on the recording medium,
a parameter is changed in accordance with the factor of the recording stop so as to reduce an influence of the factor.

13. A recording and reproducing method according to claim 6, comprising a step of,
after the recording stop occurred, in order to restart the recording,
before the pickup is located to the same position on the recording medium,
changing a parameter in accordance with the factor of the recording stop so as to reduce an influence of the factor.

14. A recording and reproducing method according to claim 7, comprising a step of,
after the recording stop occurred, in order to restart the recording,
before the pickup is located to the same position on the recording medium,
changing a parameter in accordance with the factor of the recording stop so as to reduce an influence of the factor.
